(19) United States
(12) Patent Application Publication
(10) Pub. No.: US 2015/0069057 A1
(43) Pub. Date: Mar. 12, 2015

(54) Liner and Composite Tank Assembly Method

(71) Applicants: Maurice Guitton, Lunenburg (CA); Martin Dugas, Caraquet (CA); Eric Dugas, Caraquet (CA); Neri Jean, Caraquet (CA); Jacques Dugas, Caraquet (CA)

(72) Inventors: Maurice Guitton, Lunenburg (CA); Martin Dugas, Caraquet (CA); Eric Dugas, Caraquet (CA); Neri Jean, Caraquet (CA); Jacques Dugas, Caraquet (CA)

(21) Appl. No.: 14/261,078

(22) Filed: Apr. 24, 2014

Related U.S. Application Data
(60) Provisional application No. 61/815,651, filed on Apr. 24, 2013.

(51) Int. Cl. B65D 25/14; B29C 41/04; B29C 70/36

(52) U.S. Cl. CPC B65D 25/14; B29C 70/36; B29C 41/04; B29K 2023/06; B29K 2105/0872
USPC 220/62.11; 264/511; 264/311

(57) ABSTRACT

An improved liner for a container in which gases, liquids, or powders are stored. The liner is a multi-layer structure made in a roto molding machine. The liner includes a first outer layer made of metallocene polyethylene, an intermediate gas and liquid impermeable layer, and one or more inner layers made of thermoplastic material compatible with the material stored inside the container. During the molding process, the three layers are made sequentially with the second and third layers being bonded and fused to the adjacent layer to form a uniform composite layer. The outer layer is made of metallocene polyethylene that has superior rigidity and relatively low coefficient of expansion properties making the liner less susceptible to cracking and useful as a layup structure for molding a structure around it. Once the liner is fabricated, the liner may be a build up structure to manufacturer a container or tank around the liner using either blow molding or roto molding processes.

This utility patent application is based upon and claims the priority filing date of U.S. provisional patent application (application Ser. No. 61/815,651) filed on Apr. 24, 2013,

Notice is given that the following patent document contains original material subject to copyright protection. The copyright owner has no objection to the facsimile or digital download reproduction of all or part of the patent document, but otherwise reserves all copyrights.

### BACKGROUND OF THE INVENTION

1. Field of the Invention

This invention pertains to liners for storage containers and more particular, to such liners that are more durable than liners used in the prior art and can be used to manufacture the outer container in which the liner is placed.

2. Description of the Related Art

Above ground and underground storage tanks are commonly used to store different

Above ground and underground storage tanks are commonly used to store different gases, liquids and fine solids. Such storage tanks are manufactured in different shapes adn sizes and usually made of metal or composite materials. They often include valves, ports, and internal conduits.

Two problems with large tanks made of metal are: (1) the outside surfaces and tank's support framework deteriorates when exposed to weather, and (2) material stored inside the tank may react with the tank's interior metal surfaces. Eventually, leaks or cracks are created that require repair or replacement of the entire tank. Sometimes, liners made of composite material that does not react with the stored material are placed inside the tanks to prevent deterioration of the tank's inside metal surfaces.

Tanks made of composite materials are commonly used an alternatives to metal tanks. The tanks are hollow with uniform wall thickness. The most common method to manufacture composite tanks with inside hollow cavities and with uniform side walls is to use a process known as roto-molding. One problem with large tanks made of composite materials is that composite material itself has relatively high co-efficiency of expansion. Because the container and tanks are used outdoors and exposed to different weather conditions, creaks often occur. Like metal tanks, liners made of composite material that does not react to the stored material may be placed inside the composite tanks to prevent leakage through the cracks.

What is also needed is an improved liner that can be used inside both metallic and composite tanks that is less susceptible to cracking and leaking. What is also needed is a method of manufacturing a tank made of composite material with pre-manufactured liner placed inside the mold so that the composite tank may be manufactured around the liner.

### SUMMARY OF THE INVENTION

An improved liner for a container in which gases, liquids, or powders are stored. The liner is a multi-layer structure that includes an outer layer made of metallocene polyethylene, an intermediate gas and liquid impermeable layer, and one or more inner layers made of thermoplastic material. The metallocene polyethylene layer provides rigidity and has no or very low coefficient of expansion properties making the liner less susceptible to cracking and useful as a layup structure for molding an outer structure around it. The inner most layer is made of composite material compatible with the material stored inside a storage container in which the liner is installed. During the molding process, the inner three layers are sequentially manufactures and then fused together to form a uniform composite layer. The liner may be made by blow molding or roto molding processes.

In one embodiment, the liner is a separate structure that can be inserted into an existing container or tank made of metal or composites. In a second embodiment, the liner is used as a layup structure located inside the cavity of a mold used to make a composite container or tank in which the liner will be placed. Because the liner is semi-rigid and has little or zero co-efficiency of expansion, it may be uses as a lay-up structure for either roto-molding or blow molding process. In one embodiment, the liner's outer layer which is made of composite material may become fused and integral with the container's or tanks side walls.

### DESCRIPTION OF THE DRAWINGS

FIG. 1 is a sectional side elevational view of a mold with the outer container made of composite material with the improved liner formed therein.

FIG. 2 is a sectional side elevational view of an upper section of the mold shown in FIG. 1.

FIG. 3 is a sectional side elevational view of a lower section of the mold shown in FIG. 1.

### DESCRIPTION OF THE PREFERRED EMBODIMENT(S)

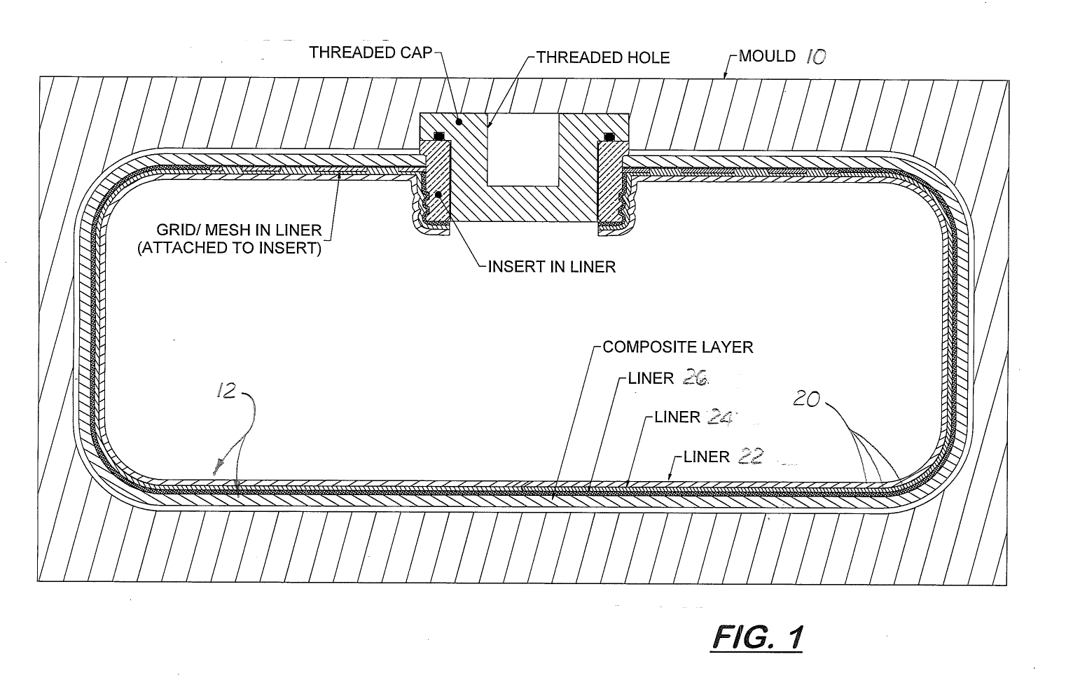

FIG. 1 is a sectional side elevational view of a mold 10 used to manufacuture a composite tank 12 made of composite material with the improved liner 20 formed therein. An improved liner 20 is specifically designed to be used with composite tanks 12 in which gases, liquids, or powders will be stored.

The liner 20 is a multi-layer structure that includes an outer layer made of metallocene polyethylene 22, an intermediate gas and liquid impermeable layer 24, and one or more inner layer 26 made of thermoplastic material. The metallocene polyethylene layer 22 provides rigidity and has relatively low coefficient of expansion properties making the liner 20 less susceptible to cracking and useful as a layup structure for molding. The two inner layers 24, 26 are made of composite material compatible with the material stored inside a storage container in which the liner is installed. The thickness of each inner layer 24, 26 and the number of inner layers 24, 26 may be selectively controlled for use with different stored materials. During the molding process, the inner three layers 22, 24, 26 are bonded and fused together to form a composite tank 12 with a durable, protective liner 20.

It should be understood, however the liner 20 described above is not limited to composite tanks or only used to make in situ tanks. It may be made separately and used with metal containers or tanks.

The liner 20 is manufactured by a roto-molding process that uses a roto-molding machine. The linear 20 is fabricated one layer at a time with allows the thickness of each layer to be precisely controlled. During fabrication, each layer 22, 24, 26 is allowed to cure and cool and the adjacent layers are then formed over the adjacent layer. The temperature and vacuum pressure is controlled so that the adjacent layers are fused together. When all of the layers have been fabricated, the entire liner 20 is then inspected using ultrasound testing procedures.

The raw material powders used to fabricate each inner layer 24, 26 are selected based on the stored material inside the tank 12.

More specifically, each layer is roto molded and formed by introducing powder resin that includes metallocene polyethylene and composite fibers into the mold cavity to create the first layer (called the inner layer 26) of the liner 20. The powder is heated to a very specific temperature so that it becomes a liquid. The mold is then rotated 360 degrees to form a layer with the desired dimensions. The above steps are repeated each time for each additional intermediate layer 24. In the preferred embodiment, the second layer 24 is made of gas and liquid impermeable material. The outside layer 22 is made of material compatible with the material exposed to the liner 20. When completed, a multi-layer liner 20 is produced that has zero coefficient of expansion, and leak resistant. Minimum thickness of each layer 22, 24, 26 should be not less then 1 mm and not thicker than 4 mm.

As shown in FIG. 3, optional metallic's inserts 90 can be in-bedded in the liner 20 to server as supports fort pipe connections.

Bow molding liner is another technology who could used to make the multi layer liner 20. The bow molding process is similar to the process used to fabricate plastic bottles. It is possible to coextruded two, three materials together like a big tube in continuous mode. Very special machinery and equipments must be used to make liners. This technology is used to produce millions of parts.

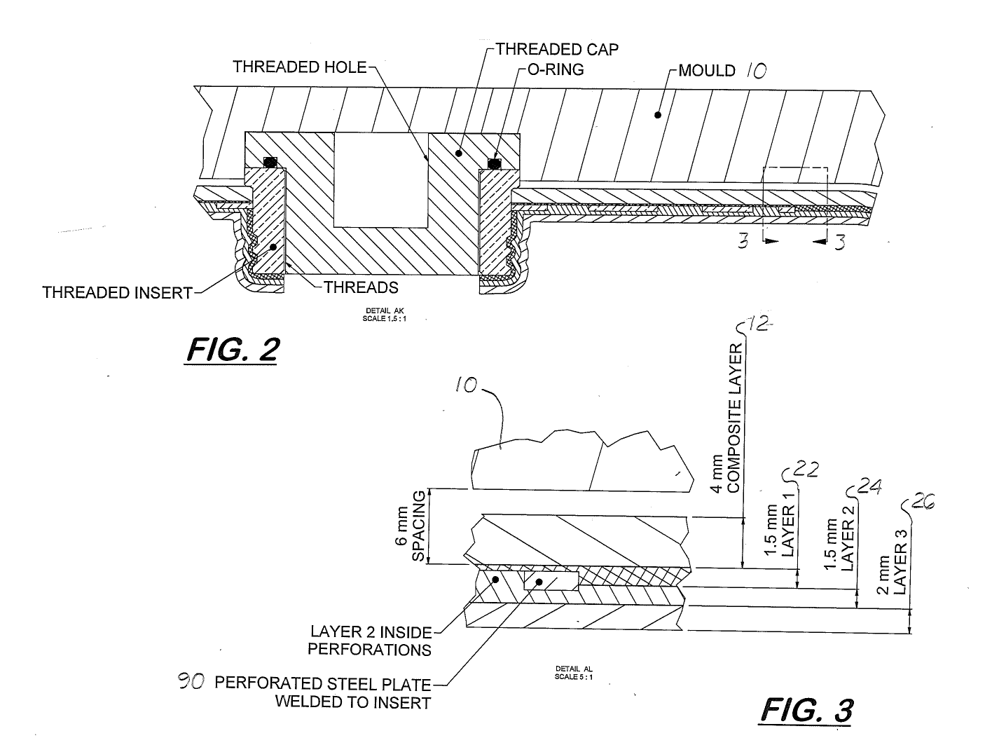

Also disclosed is a method for fabricating a composite tank 12 using the liner 20 as a build up structure that becomes permanently installed inside the tank 12. FIG. 2 is a sectional side elevational view of an upper section of the mold shown in FIG. 1. FIG. 3 is a sectional side elevational view of a lower section of the mold shown in FIG. 1. During fabrication, the liner 20 is separately manufactured and placed into the mold 10 used to manufacture the tank 10 Fiber plies (not shown) are then built-up around the liner 20. As stated above, because the liner 20 is made of material that has zero coefficient of expansion, is it ideal for use as a layup structure. The number of plies are used determine the thickness of the sidewalls of the tank 10. As stated above, during the lay-up step optional inserts 90 can be added in the structure.

In compliance with the statute, the invention described has been described in language more or less specific as to structural features. It should be understood however, that the invention is not limited to the specific features shown, since the means and construction shown, comprises the preferred embodiments for putting the invention into effect. The invention is therefore claimed in its forms or modifications within the legitimate and valid scope of the amended claims, appropriately interpreted under the doctrine of equivalents.

We claim:

1. An improved liner for a container or tank configured to hold a gas, liquid, or powder comprising:
a. an outer layer made of metallocene polyethylene and bonded with fibers laminated to a composite structure;
b. an intermediate layer made of material that is gas and liquid impermeable; and.
c. at least one inner layer formed over the intermediate layer and in contact with and made of material compatible with the substance to be stored in the container or tank.

2. A method of manufacturing a liner, comprising the following steps.
a. selecting a roto molding machine;
b. selecting a liner for a container with a first layer made of metallocene polyethylene, a second layer adjacent to the first layer that made of composite material impermeable to the material stored in the container, and one or more outer layers made of composite material;
c. selecting a mold for the liner for use in a roto molding machine;
d. manufacturing the first layer made of metallocene polyethylene and resin in the mold using the roto molding machine;
e. allowing the first layer to cool;
f. manufacturing a second layer made of composite material that fuses with the first layer and is impermeable to the material to be stored in the container;
g. allowing the second layer to cool;
h. manufacturing at least one outer layer around the second layer, the outer layer being made of composite material that a fuses with the second layer under suitable temperature and pressure;
i. removing the liner from the roto-mold machine.

3. A method of manufacturing an outer container or tank with an rigid, durable inner liner, comprising the following steps:
a. selecting a clean suitable liner made of material with zero co-efficiency of expansion;
a. installing the liner in the mold cavity in a mold;
b. laying up around the liner with fibers according a engineering layup plan;
c. placing the liner and the fiber layup into the mold cavity;
d. closing the mold and injecting suitable resin;
e. applying vacuum and heat to the mold;
f. removing the mold from the oven;
g. cooling the mold, and,
h. removing the liner from the mold.
